(19) United States
(12) Patent Application Publication
(10) Pub. No.: US 2006/0285173 A1
(43) Pub. Date: Dec. 21, 2006

(54) Scanning apparatus and scanning method

(75) Inventor: Houng-Kyu Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/434,859

(22) Filed: May 17, 2006

(30) Foreign Application Priority Data
Jun. 15, 2005 (KR) 2005-51513

(51) Int. Cl. H04N 1/40

(52) U.S. Cl. 358/449; 358/505; 358/528

(57) ABSTRACT

The invention provides a scanning apparatus, including an information storage unit to store information on a size of a recording medium on which an image is formed, a scanning unit to scan the image and to generate a corresponding image signal, a driving unit to drive the scanning unit to perform scanning while moving in a predetermined direction across the recording medium, and a controlling unit to control the driving unit to move the scanning unit within a range corresponding to the information.

### CROSS-REFERENCE TO RELATED APPLICATION

This application claims priority from Korean Patent Application No. 2005-51513, filed on Jun. 15, 2005, in the Korean Intellectual Property Office, the disclosure of which is incorporated herein by reference.

### BACKGROUND OF THE INVENTION

1. Field of the Invention

An aspect of the present invention relates to a scanning apparatus and a scanning method, and, more particularly, to a scanning apparatus and a scanning method capable of reducing unnecessary time and work required to complete scanning operations.

2. Description of the Related Art

Scanning apparatuses such as scanners, copying machines, and multifunction printers scan images such as characters, pictures, and photographs formed on recording media, such as paper, to obtain image data corresponding to the images.

FIGS. 1A and 1B illustrate a conventional scanning apparatus. The scanning apparatus 1 of FIGS. 1A and 1B includes a scanning unit 3. The scanning unit 3 scans the image of a recording medium 5 set on a glass plate (not shown). The scanning unit 3 may be realized by a charge-coupled device (CCD) or a contact image sensor (CIS). The scanning apparatus 1 may further include a driving unit (not shown) such as a motor and a belt to move the scanning unit 3 so that the scanning unit 3 may perform scanning over the length and the width of the recording medium.

The scanning apparatus 1 of FIG. 1A controls the driving unit so that the scanning unit 3 moves from a home position (refer to position “a” of FIG. 1A) toward the right hand side of FIG. 1A along the recording medium 5 when a scanning command is received from a user. The scanning unit 3 scans the image of the recording medium 5 while moving over the recording medium 5 to generate image data. As illustrated in FIG. 1B, the scanning apparatus 1 controls the driving unit so that the scanning unit 3 stops moving and returns toward the home position (position “a” of FIG. 1A) when the scanning unit 3 completes the scanning operation and reaches a position b (position “b” of FIG. 1A).

Since the conventional scanning unit 3 performs scanning while reciprocating from the home position “a” to the final position “b” regardless of the size of the recording medium 5, as described above, unnecessary time and work required to perform scanning operations occur where the recording medium 5 being scanned is shorter in length than the length of the reciprocating range (the length from “a” to “b”).

### SUMMARY OF THE INVENTION

Accordingly, an aspect of the present invention provides a scanning apparatus and a scanning method capable of reducing unnecessary time and work required to perform scanning operations. Another aspect of the present invention provides a scanning apparatus and a scanning method capable of improving convenience of use for a user.

The foregoing and/or other aspects of the present invention may be achieved by providing a scanning apparatus, including an information storage unit to store information on a size of a recording medium on which an image is formed, a scanning unit to scan the image and to generate a corresponding image signal, a driving unit to drive the scanning unit to perform scanning while moving in a predetermined direction across the recording medium, and a controlling unit to control the driving unit to move the scanning unit within a range corresponding to the information.

According to an aspect of the present invention, the controlling unit controls the driving unit to perform a preliminary scan on the image and stores information on the size of the recording medium based on the image signal of the image obtained by the preliminary scan as the recording medium size information in the information storage unit.

According to an aspect of the present invention, the scanning apparatus further comprises an input unit to receive recording medium determining information from a user, wherein the information storage unit stores the recording medium size information corresponding to the recording medium determining information, and wherein the controlling unit controls the driving unit based on the recording medium size information corresponding to the recording medium determining information.

The foregoing and/or other aspects of the present invention may be achieved by providing a method of operating a scanning apparatus including a scanning unit, the method comprising storing information describing a size of a recording medium on which an image is formed, scanning the image while moving the scanning unit across the recording medium in a predetermined direction, determining whether the scanning unit is moved within a range corresponding to the information, and stopping the scanning when the scanning unit is determined to have moved out of the range corresponding to the information.

According to an aspect of the present invention, the scanning method further comprises performing a preliminary scan on the image, wherein, in the storing, information on the size of the recording medium based on the image signal of the image obtained by the preliminary scan is stored as the recording medium size information in the information storage unit.

According to an aspect of the present invention, the scanning method further comprises receiving recording medium determining information from a user, wherein, in the storing, the recording medium size information corresponding to the recording medium determining information is stored, and wherein, in the determining, it is determined whether the scanning unit is moved within the range corresponding to the recording medium size information based on the recording medium size information corresponding to the recording medium determining information.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompany drawings, of which:

FIGS. 1A and 1B illustrate a conventional scanning apparatus;

FIG. 2 is a block diagram illustrating the structure of a scanning apparatus according to an embodiment of the present invention;

FIGS. 3A and 3B illustrate the scanning apparatus according to the embodiment of the present invention;

FIG. 4 is a flowchart schematically illustrating a first embodiment of an operation of the scanning apparatus of the present invention;

FIG. 5 is a flowchart schematically illustrating another embodiment of the operation of the scanning apparatus of the present invention; and

FIG. 6 is a flowchart schematically illustrating another embodiment of the operation of the scanning apparatus of the present invention.

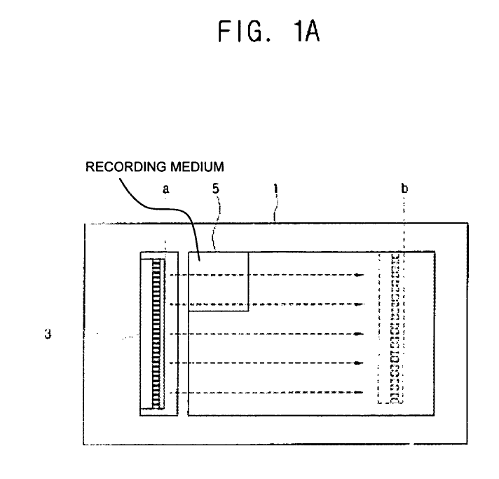

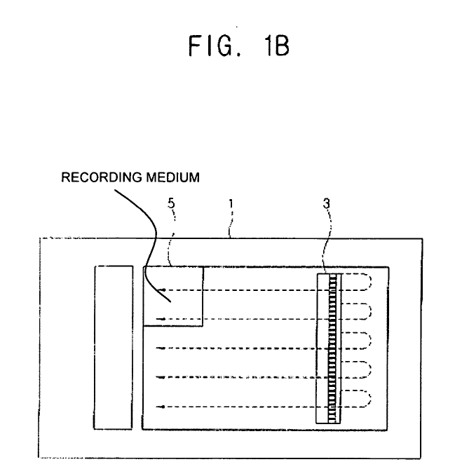

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

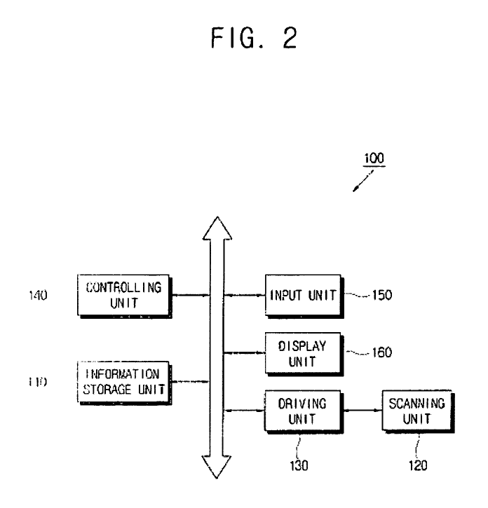

FIG. 2 is a block diagram illustrating the structure of a scanning apparatus 100 according to an embodiment of the present invention. The scanning apparatus 100 may comprise a scanner, a copying machine, a multifunction printer, etc., or a combination thereof which scans images formed on recording media, such as paper or other types of recording media, to provide image data corresponding to the images.

As illustrated in FIG. 2, the scanning apparatus 100 includes an information storage unit 110, a scanning unit 120, a driving unit 130, and a controlling unit 140. The information storage unit 110 stores recording medium size information on the size of the recording medium to be scanned. The recording medium size information may be information identifying various sizes of recording media such as A4 paper, B5 paper, a certificate of residence, a name card, a receipt, etc. The information storage unit 110 of the embodiment of the present invention may comprise a memory, such as a flash memory.

The scanning unit 120 scans the recording medium on which an image is formed and may comprise a charge-coupled device (CCD), a contact image sensor (CIS), etc. The scanning unit 120 is aligned over the recording medium to be scanned and scans a part of the recording medium or gradually scans the entire recording medium while moving in a direction roughly perpendicular to the direction in which the scanning unit 120 is aligned. When the scanning unit 120 comprises the CCD, a sensor (not shown) is aligned to be perpendicular to the scanning direction. The scanning unit 120 generates an image signal corresponding to the image through the scanning and the generated image signal is AD converted to be provided as image data by a predetermined image processing unit (not shown).

The driving unit 130 drives the scanning unit 120 to move toward the recording medium to be scanned in the scanning direction based on the instruction of the controlling unit 140. The driving unit 130 may comprise a motor or a belt and may further comprises a driving controller (not shown) to control the motor or the belt.

In a first embodiment of the invention, the controlling unit 140 controls the driving unit 130 to drive the scanning unit 120 to move in the range corresponding to the recording medium size information stored in the information storage unit 110. In this case, the controlling unit 140 will have controlled the driving unit to drive the scanning unit such that the scanning unit will have previously scanned the image so as to obtain information on a size of the recording medium on which the image is printed. Thus, the controlling unit 140, according to an embodiment of the invention, obtains the information on the size of the recording medium based on the image signal obtained by a previously performed scanning operation.

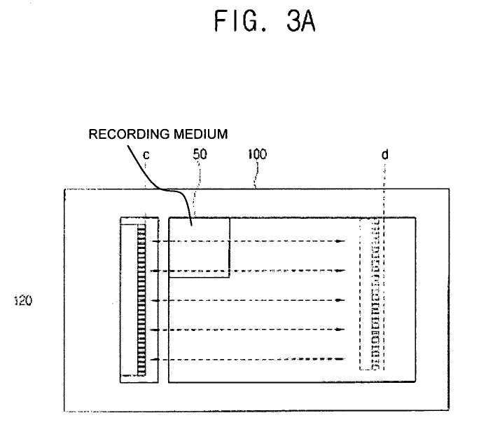

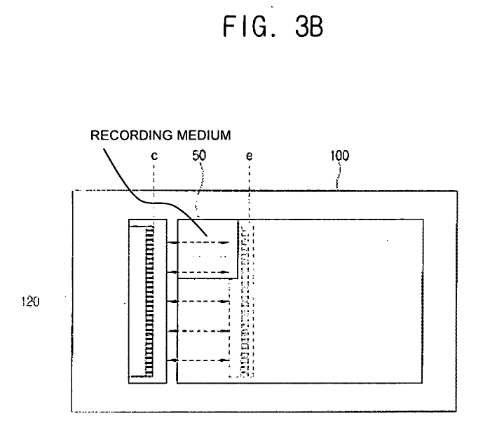

In greater detail, as illustrated in FIG. 3A, the controlling unit 140 controls the driving unit 130 to drive the scanning unit 120 to perform scanning on the recording medium 50 while moving from the home position (position “c” of FIG. 3A) to the final position (position “d” of FIG. 3A). The controlling unit 140 concurrently determines the size of the recording medium 50 by finding the edge of the recording medium 50 with reference to the image data generated by the performing of the scanning. For example, the controlling unit 140 determines that a scanned area does not include the recording medium 50 when the image data generated by the scanning is empty (or generates an image signal with a zero (0) amplitude). In contrast, the controlling unit 140 determines that a scanned area does include the recording medium 50 when the image data generated by the scanning is not empty (or generates an image signal with a non-zero, i.e., level 1, amplitude). As such, by applying the determinations as to the location of the recording medium 50 to be scanned, the controller 140 determines the size of the recording medium 50. The controlling unit 140 then stores the information on the determined size of the recording medium in the information storage unit 110 as the recording medium size information. The controlling unit 140 may also index the recording medium size information to store the recording medium size information in the information storage unit 110. For example, the controlling unit 140 may store recording medium determining information to distinguish or determine recording media such as A4 paper, B5 paper, a certificate of residence, a name card, and a receipt and the recording medium size information corresponding to the recording medium determining information in the information storage unit 110.

According to another embodiment of the invention, the previously performed scanning operation may be a scanning operation conducted on a first sheet of recording medium that is picked up from a stack of recording media, where the entire stack is to be scanned sheet by sheet. Here, the controlling unit 140 recognizes that multiple sheets of recording medium are to be scanned and that each sheet has a substantially similar size and shape as the others. The controlling unit 140 then conducts a preliminary scan on the first sheet to determine the size and shape of each sheet in the stack and records the result of the preliminary scanning operation. Thereafter, the controlling unit drives the scanning unit 120 to scan each sheet of the stack according to the determined size and shape of each sheet in the stack.

In yet another embodiment of the invention, the scanning apparatus 100 comprises an input unit 150 to receive recording medium determining information from a user. According to the embodiment, the input unit 150 includes a plurality of keys to receive a key input from the user as the recording medium determining information. In this case, the controlling unit 140 stores the recording medium determining information received from the user as a shortened key in the information storage unit 110 together with the corresponding recording medium size information. For example, the controlling unit 140 stores information that specifies that the size of the recording medium to be scanned corresponds to the size of a certificate of residence in the information storage unit 110 when a “key1” is received. Similarly, the controlling unit 140 stores information that specifies that the size of the recording medium to be scanned corresponds to the size of a name card in the information storage unit 110 when a “key2” is received. As yet another example, the controlling unit 140 stores information that specifies that the size of the recording medium to be scanned corresponds to the size of a receipt in the information storage unit 110 when a “key3” is received.

As illustrated in FIG. 3B, when the size of the recording medium 50 corresponds to the size of a certificate of residence, so that the user enters the “key1” input through the input unit 150 to indicate that the recording medium to be scanned corresponds in size to that of the certificate of residence, the controlling unit 140 reads the recording medium size information on a certificate of residence from the information storage unit 110 to control the driving unit 130 so that the scanning unit 120 performs scanning while moving from the home position “c” to the position “e,” shown in FIG. 3B. As such, the scanning unit 120 scans an area having a size that corresponds to the stored size of a certificate of residence.

Here, it is noted that this embodiment of the invention could be applied to a situation where the user intend to have a stack of similarly sized recording media scanned. The controlling unit 140 recognizes that a stack of recording media are to be scanned and, thus, recognizes that the inputted information relating to the size and the shape of a single sheet of recording medium in the stack applies to each sheet in the stack. Thus, the controller 140 drives the scanning unit 120 to scan each sheet in the stack according to the inputted information.

The controlling unit 140 of the above described embodiments of the present invention may be realized by a computer program executed by a microprocessor. In this case, the computer program may be stored in a memory such as a flash memory. The computer program is programmed to a language suitable for the microprocessor to perform the above described operations of the controlling unit 140.

The scanning apparatus 100 of the embodiment of the present invention may further include a display unit 160 to display the state of the scanning apparatus 100 to the user. The display unit 160 also may allow the user to set and modify the shortened keys through the input unit 150.

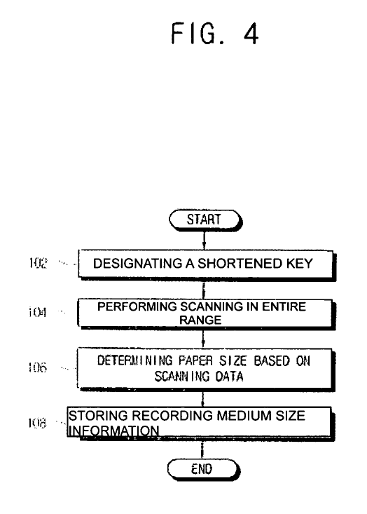

A method of operating the scanning apparatus 100 according to a first embodiment of the present invention will now be described with reference to FIG. 4. FIG. 4 is a flowchart schematically illustrating an operation of the scanning apparatus 100. The input unit 150 of the scanning apparatus 100 is instructed by the user to designate a shortened key and receives the shortened key to be set (102). The controlling unit 140 of the scanning apparatus 100 controls the driving unit 130 so that the scanning unit 120 performs scanning on the recording medium 50 over the entire range from the home position “c” to the final position “d” (104).

The controlling unit 140 grasps the edge of the recording medium 50 based on the image data obtained by performing scanning to determine the size of the recording medium 50 (106). The controlling unit 140 then stores information on the determined size of the recording medium 50 as the recording medium size information in the information storage unit 110 (108).

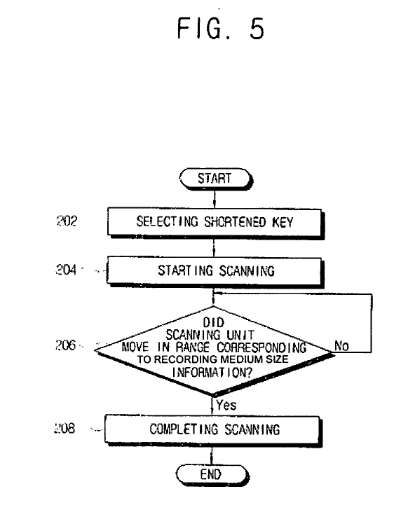

FIG. 5 is a flowchart illustrating another operation of the scanning apparatus 100 of the above described embodiment of the present invention. The input unit 150 of the scanning apparatus 100 receives a shortened key from a user (202). When the input unit 150 receives a scanning command from a user, the controlling unit 140 of the scanning apparatus 100 controls the driving unit 130 so that the scanning unit 120 performs scanning on the recording medium 50 while moving from the home position “c” from which scanning begins (S204).

The controlling unit 140 reads the recording medium size information corresponding to the shortened key received through the input unit 150 from the information storage unit 110 to determine whether scanning unit 120 is moved to the position corresponding to the recording medium size information (206). When it is determined that the scanning unit 120 did not move to the position corresponding to the recording medium size information (“No” of 206), the controlling unit 140 controls the driving unit 130 so that the scanning unit 120 continuously performs scanning while moving (204). When it is determined that the scanning unit 120 moved to the position corresponding to the recording medium size information (“Yes” of 206), the controlling unit 140 controls the driving unit 130 so that the scanning unit 120 stops moving and that the scanning unit 120 returns to the home position “c” (208).

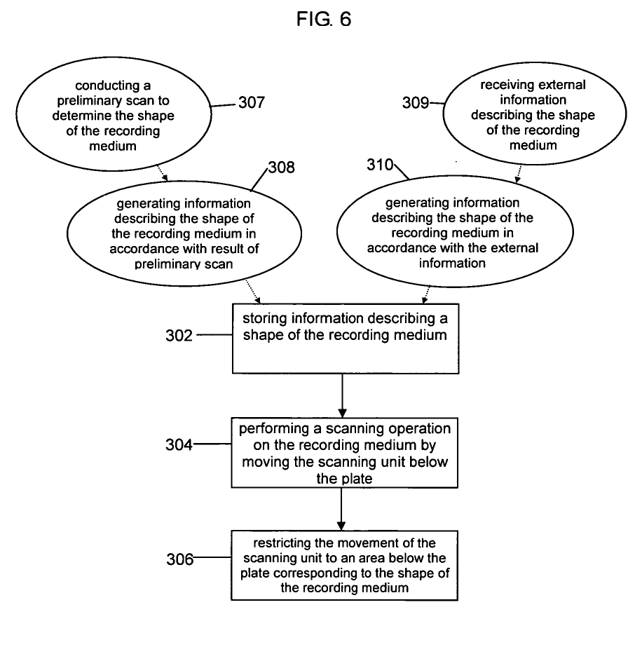

With reference to FIG. 6, another embodiment of a method of operating a scanning apparatus will be described. According to this embodiment, the apparatus includes a scanning unit disposed below a plate on which a recording medium, having a surface to be scanned, is supported. Here, the method comprises storing information describing a shape of the recording medium (302), performing a scanning operation on the recording medium by moving the scanning unit below the plate (304), and restricting the movement of the scanning unit to an area below the plate corresponding to the shape of the recording medium (306).

The storing operation 302 may comprise conducting a preliminary scan to determine the shape of the recording medium (307), and generating the information describing the shape of the recording medium in accordance with a result of the preliminary scan (308).

Alternatively, the storing operation 302 may comprise receiving external information describing the shape of the recording medium (309), and generating the information describing the shape of the recording medium in accordance with the received external information (310).

According to aspects of the invention, the controlling unit 140 controls the driving unit 130 so that, when a user sets a shortened key to represent a particular size of a recording medium and enters the set shortened key via the input unit 150, the scanning unit 120 performs scanning based on the size of the recording medium corresponding to the set shortened key in response to at least one scanning command from the user.

As is described above, according to aspects of the present invention, providing a scanning apparatus and a scanning method capable of preventing unnecessary time and work to perform scanning operations from being generated is possible. Also, according to the present invention, providing a scanning apparatus and a scanning method capable of improving the convenience of a user is possible.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of operating a scanning apparatus including a scanning unit, the method comprising:
storing information relating to a size of a recording medium on which an image is formed;
scanning the image while moving the scanning unit across the recording medium in a predetermined direction;
determining whether the scanning unit is moved within a range corresponding to the information; and
stopping the scanning when the scanning unit is determined to have moved out of the range corresponding to the information.

2. The method according to claim 1, further comprising performing a preliminary scan on the image, wherein, in the storing operation, the information on the size of the recording medium that is based on the image signal of the image obtained by the preliminary scan is stored as the recording medium size information.

3. The method according to claim 1, further comprising receiving recording medium determining information from a user, wherein, in the storing, the stored information corresponds to the recording medium determining information, and wherein, in the determining, whether the scanning unit is moved within the range corresponding to the recording medium determining information is determined.

4. A scanning apparatus, comprising:
an information storage unit to store information relating to a shape of a recording medium to be scanned;
a scanning unit to be driven to scan the recording medium and to generate an image signal based on the scan; and
a controlling unit to control the driving of the scanning unit in accordance with the shape of the recording medium.

5. The scanning apparatus according to claim 4, further comprising a driving unit to drive the scanning unit.

6. The scanning apparatus according to claim 4, wherein the apparatus is connected to a copying machine and/or a multi-functional printer.

7. The scanning apparatus according to claim 4, wherein the stored information describing the shape of the recording medium is indexed to refer to particular type of recording media.

8. The scanning apparatus according to claim 4, wherein the information storage unit comprises a flash memory.

9. The scanning apparatus according to claim 4, wherein the scanning unit comprises a charge coupled device, the charge coupled device extending in a first direction and the scanning unit being driven in a second direction perpendicular to the first direction.

10. The scanning apparatus according to claim 4, wherein the scanning unit comprises a contact image sensor.

11. The scanning apparatus according to claim 4, wherein the controlling unit controls the scanning unit to conduct a preliminary scanning operation to determine the shape of the recording medium.

12. The scanning apparatus according to claim 11, wherein the controlling unit determines the shape of the recording medium by locating edges of the recording medium with reference to image data generated by the preliminary scanning.

13. The scanning apparatus according to claim 12, wherein the controlling unit determines that a scanned area does not include the recording medium when the image data generated by the preliminary scanning is empty, and the controlling unit determines that a scanned area does include the recording medium when the image data generated by the preliminary scanning is not empty.

14. The scanning apparatus according to claim 11, wherein, where the recording medium is a part of a stack of recording media, each recording medium in the stack having a substantially similar size and shape as that of the recording medium, the preliminary scanning operation is conducted once and determines the shape of each recording medium in the stack.

15. The scanning apparatus according to claim 4, further comprising an input unit to receive information from a user describing the shape of the recording medium.

16. The scanning apparatus according to claim 15, wherein the input unit comprises a plurality of input keys to respectively correspond to particular sizes of recording media.

17. The scanning apparatus according to claim 16, wherein a user designates the particular input key from among the plurality of input keys that corresponds to a type of a recording medium having a shape that is substantially similar to that of the recording medium.

18. The scanning apparatus according to claim 15, wherein, where the recording medium is a part of a stack of recording media, each recording medium in the stack having a substantially similar shape as that of the recording medium, the information from the user is inputted once and describes the shape of each recording medium in the stack.

19. The scanning apparatus according to claim 4, wherein the controlling unit comprises a computer program executed by a microprocessor.

20. The scanning apparatus according to claim 4, further comprising a display unit to display a state of the scanning apparatus to a user.

21. A computer readable medium to execute the method according to claim 1.
